(19) United States
(12) Patent Application Publication
(10) Pub. No.: US 2022/0222176 A1
(43) Pub. Date: Jul. 14, 2022

(54) DYNAMIC CONTROL OF SHARED RESOURCES BASED ON A NEURAL NETWORK

(71) Applicant: Intel Corporation, Santa Clara, CA (US)

(72) Inventors: Anna DREWEK-OSSOWICKA, Gdansk (PL); Kamil Tomasz ANDRZEJEWSKI, Maldyty (PL); Rameshkumar G. ILLIKKAL, Folsom, CA (US); Andrew J. HERDRICH, Hillsboro, OR (US); Slawomir PUTYRSKI, Gdynia (PL); Shruthi VENUGOPAL, Austin, TX (US)

(21) Appl. No.: 17/709,960

(22) Filed: Mar. 31, 2022

(51) Int. Cl. G06F 12/084; G06F 9/50; G06N 3/08; G06N 3/04

(52) U.S. Cl. CPC G06F 12/084; G06N 3/0454; G06N 3/084; G06F 9/5016

(57) ABSTRACT

Examples described herein relate to circuitry to utilize a proportional, derivative, integral neural network (PIDNN) controller to adjust one or more parameters allocated to a first group of one or more workloads based on one or more target parameters for a second group of one or more workloads. In some examples, the second group of one or more workloads are a same, lower, or higher priority level than that of the first group of one or more workloads.

### BACKGROUND

In environments such as a datacenter, workloads utilize hardware resources that are shared by other workloads. However, workload performance is sensitive to use of shared hardware resources. Workload performance can fluctuate when more than one application utilizes shared resources. For example, applications and workloads sharing resources can experience variable performance, including throughputs and tail latencies. Datacenter owners and operators can overprovision shared hardware resources to ensure acceptable performance of priority applications. However, overprovisioning resources can increase datacenter total cost of ownership (TCO) as shared hardware resources can be underutilized and execute fewer workloads.

### BRIEF DESCRIPTION OF THE DRAWINGS

FIG. 1 depicts an example system.

FIG. 2 shows an example system.

FIG. 3 depicts an neural network that can be used as a PID controller.

FIG. 4 depicts a single neuron schema that can be used in an example output neuron.

FIG. 5 depicts an example control loop utilizing a neural network.

FIGS. 6A-6C present dynamics of a model.

FIG. 7 depicts operation of a controlled object.

FIG. 8 depicts an example pseudocode for dynamic linear mapping of inputs to a neural network.

FIG. 9 depicts an example of a process to perform dynamic linear mapping of inputs to a neural network.

FIG. 10 depicts an example environment.

FIG. 11 depicts an example control loop.

FIG. 12 depicts an example computing system.

FIG. 13 depicts an example system.

### DETAILED DESCRIPTION

Intel® Resource Director Technology (RDT) is a collection of technologies that allocates shared hardware resources such as Last Level Cache (LLC) and Memory Bandwidth to applications. RDT can perform at least Memory Bandwidth Monitoring (MBM), Memory Bandwidth Allocation (MBA), Cache Monitoring Technology (CMT), Cache Allocation Technology (CAT) and Code and Data Prioritization (CDP). In a similar manner, AMD Platform Quality of Service (AMD QoS) provides allocation of at least some of the same resources to applications. Similar technologies can be used with other processor designers or manufacturers including ARM®, Qualcomm®, IBM®, Nvidia®, Broadcom®, Texas Instruments®, among others.

For example, MBM can provide event reporting of L3 cache misses per application. Reporting local memory bandwidth can include a report of bandwidth of a thread accessing memory associated with the local socket. In a dual socket system, the remote memory bandwidth can include a report the bandwidth of a thread accessing the remote socket. For example, MBM can provide monitoring of multiple virtual machines (VMs), containers, or applications independently, which can provide memory bandwidth monitoring for running threads simultaneously.

For example, MBA can provide control over memory bandwidth available to workloads, enabling new levels of interference mitigation and bandwidth shaping for “noisy neighbors” present on the system. Memory bandwidth can represent a rate at which data can be read from or stored into a memory device or storage device by a processor.

For example, CMT can provide monitoring of last-level cache (LLC) utilization by individual threads, applications, VMs, or containers. CMT can enable tracking of the L3 cache occupancy, enabling detailed profiling and tracking of threads, applications, or virtual machines. CMT can enables resource-aware scheduling decisions, aid in “noisy neighbor” detection and assist with performance debugging.

For example, CAT can provide software-guided redistribution of cache capacity, enabling important data center requesters to benefit from improved cache capacity and reduced cache contention. CAT can provide an interface for the OS or hypervisor to group requesters into classes of service (CLOS) and indicate the amount of last-level cache available to a CLOS. These interfaces can be based on MSRs (Model-Specific Registers). CAT may be used to enhance runtime determinism and prioritize important requesters such as virtual switches or Data Plane Development Kit (DPDK) packet processing apps from resource contention across various priority classes of workloads. CAT can allow an operating system (OS), hypervisor, or virtual machine manager (VMM) to control allocation of a central processing units (CPU) shared LLC.

For example, CDP can provide separate control over code and data placement in the last-level (L3) cache (e.g., LLC). Certain types of workloads may benefit with increased runtime determinism, enabling greater predictability in application performance.

To manage shared hardware resources, such as memory bandwidth, RDT can utilize a control loop to dynamically control memory bandwidth to provide performance of high priority (HP) workloads by throttling low priority (LP) workloads that can be considered a noisy neighbor. Allocation of memory bandwidths to LP workloads can be reduced to provide better performance for HP workloads. As high and low priority workloads can coexist with reduced interference, system density can increase and TCO can decrease.

A proportional, derivative, integral (PID) controller can be used to dynamically manage allocation of shared or unshared hardware resources. The PID controller is a single-input single-output (SISO) control system that receives memory access latency as an input and outputs memory bandwidth allocation for LP workloads. A dedicated team of engineers working with a customer on the platform configuration and workload mixes can utilize an extensive regression suite and testing with multitudes of runtimes to configure the PID controller to achieve stability and acceptable behavior under known conditions. Tuning of the PID controller is workload-specific, and may be performed for different generations. The PID controller may not be tuned to address unforeseen corner cases that were not identified during manual tuning.

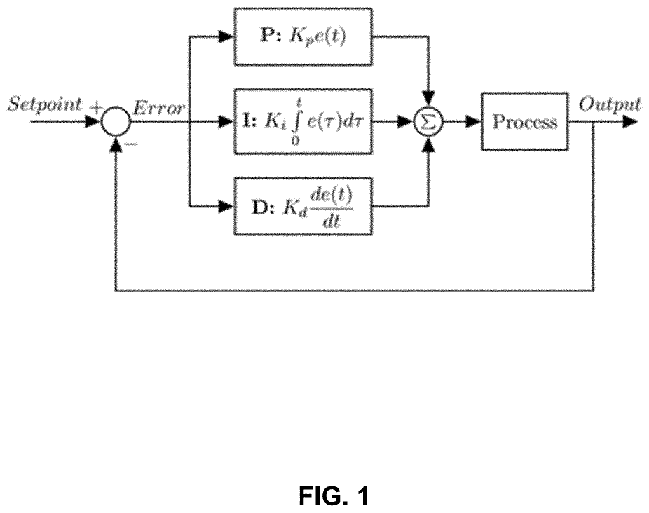

FIG. 1 depicts an example system. A PID controller provides a control loop with a single input (Setpoint) and a single output (Output). Manual (e.g., human) tuning can be performed for parameters Kₚ, Kᵢ and K_{d} for proper controller operation and can be limited to Single Input Single Output (SISO) and may not apply to Multiple Input Multiple Output (MIMO) scenarios.

At least to provide dynamic allocation of hardware resources to workloads, a PID can utilize a machine learning-based (e.g., neural network) control scheme to train PID parameters for dynamic resource and performance control. A PIDNN can refer to a PID controller integrated with a neural network to adjust weights. Post-silicon tuning and re-tuning of a PID can potentially be avoided or reduced using PIDNN. In addition, the PIDNN can control resource allocations including memory bandwidth and cache allocated to a process as well as adjust one or more of: core frequency, power level, processor frequency, device interface bandwidth, memory capacity, thermal state (e.g., temperature of a device or system of devices), failure rate (e.g., number of errors identified during operation such as correctable or uncorrectable bit errors), and other hardware configurations. The PIDNN can automatically update its weights via backpropagation, so manual tuning or re-tuning may not be performed. In some examples, the PIDNN can provide control of multiple inputs and multiple outputs (MIMO) and/or single input single output (SISO) systems. Use of a PIDNN can manage tail latencies, provide deterministic throughput, and reduce use of overprovisioning hardware resources.

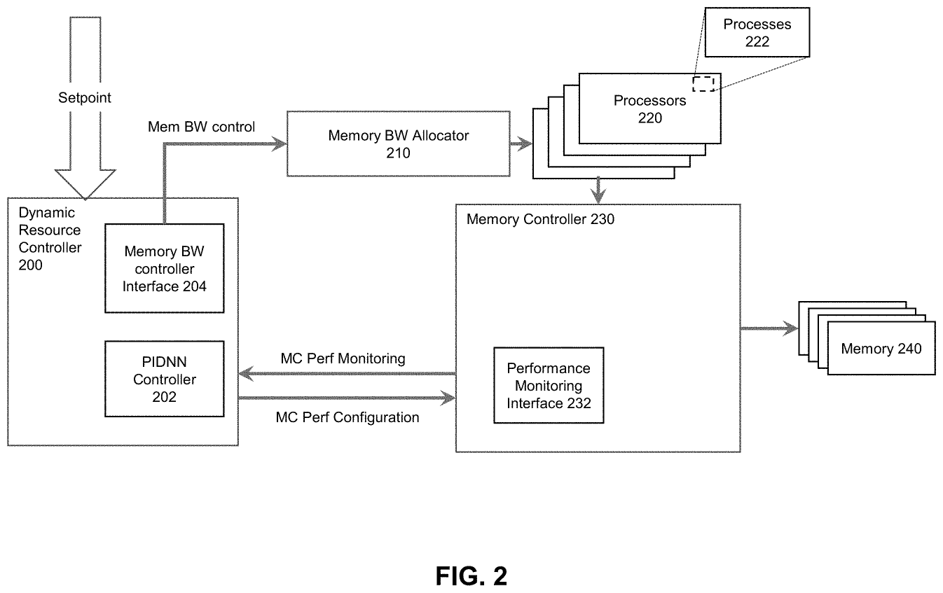

FIG. 2 shows an example system. In some examples, a power control unit (PCU) for one or more processors 220 or memory devices 240, or software or firmware executing on microcontrollers in a system agent or uncore can include or utilize dynamic resource controller 200 to control allocation of shared resource parameters to processes 222. Dynamic resource controller 200 can control memory bandwidth (BW) allocated to processes 222 executed by processors 220 in memory devices 240. Processes 222 can also include one or more of: a virtual machine (VM), application, container, microservice, thread, process, workload, and/or function. Processes 222 can have an associated priority level such as high or low. In some examples, one or more of processes 222 can have an associated class of service (CoS) or service level agreement (SLA) parameters related at least to memory bandwidth and cache allocation. For example, in some examples, a processor core can execute processes of a same priority level or CoS. A workload of a process 222 can be associated with a memory class of service (memCLOS). Workloads executed by a processor core can be allocated to a memCLOS, to set a memory bandwidth priority for the workload.

Dynamic resource controller 200 can utilize PIDNN controller 202 to control memory controller (MC) performance configurations based on monitored MC performance (MC Perf Monitoring) from performance monitoring interface 232 of memory controller 230. PIDNN controller 202 can implement a control loop for memory bandwidth when two or more workloads are running simultaneously and utilize shared memory bandwidth resources. As described herein, PIDNN controller 202 can utilize a self-tuning neural network that operates in SISO or MIMO mode and controls one or more resources such as memory bandwidth allocation to a low priority (LP) process.

PIDNN controller 202 can adjust one or more other parameters (e.g., cache allocation, memory allocation) based on setpoints or performance targets. In some examples, PIDNN controller 202 can configure memory utilization of a LP process based a given setpoint. For example, a setpoint utilized by PIDNN controller 202 can be specified, by an OS, orchestrator or operator, as memory controller queue depth or occupancy (e.g., RPQ_OCCUPANCY). PIDNN controller 202 can adjust memory bandwidth allocation to an LP process so that an error or difference between the setpoint and measured queue depth or occupancy is reduced to zero. In some examples, PIDNN controller 202 can adjust memory bandwidth allocation to an LP process using an interface to a Memory Bandwidth Allocation (MBA) hardware.

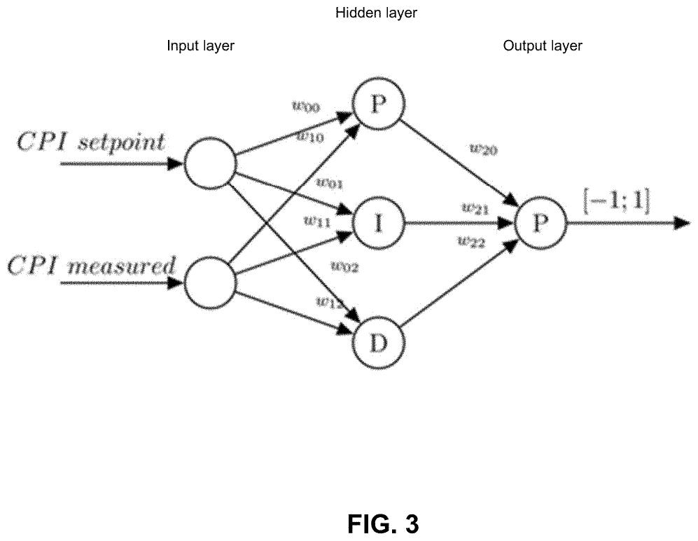

FIG. 3 depicts an neural network that can be used as a PIDNN controller. In some examples, a neural network includes an input layer, one hidden layer, and an output layer with 2, 3, and 1 neurons respectively, but other numbers of layers and neurons may be used. The input layer can include two not-activated neurons where one neuron receives a setpoint value and another neuron receives an output of the controlled process. The hidden layer can include three neurons which are activated by a proportional (P) function, integral (I) function, and derivative (D) function respectively, to achieve equivalent properties to the proportional, integral, and derivative parts of PID controller. The output layer can include one neuron, which can be activated by the proportional function.

This example of a neural network utilizes a single input with a single output. Inputs can include a cycles per instruction (CPI) setpoint such as desired CPI value for a high priority workload. In some examples, a lower CPI value can reduce total execution time of a workload whereas a higher CPI value can increase total execution time of a workload. The neural network can adjust measured CPI value to match the CPI setpoint. The measured CPI can indicate CPI value associated with a high priority workload. For example, an operator, OS, and/or orchestrator can provide the CPI setpoint whereas performance monitoring counters in the system can provide the measured CPI.

The neural network can output a percentage of memory bandwidth allocated to the LP workload. Where multiple applications share use of a memory resource, in some examples, the neural network can adjust memory bandwidth allocated to the low priority workload to assist a high priority workload achieve an associated CPI setpoint.

Initial values of weights, which connect the input layer and the hidden layer can be set to w₀ᵢ=+1 and w₁ᵢ=−1, i=0, 1, 2. As a result of that setting, a difference between setpoint and measured CPI values can be calculated and passed to the P, I, and D neurons. The remaining weights can be initially determined by basic PID control rule described in Peng, W. et al., “Decoupling Control Based on PID Neural Network for Deaerator and Condenser Water Level Control System,” (July 2015). In some examples, the initial values of weights, which connect the hidden layer and the output layer can be set to w₂ᵢ=0.1, i=0, 1, 2. Weights of one or more layers can be adjusted in back propagation.

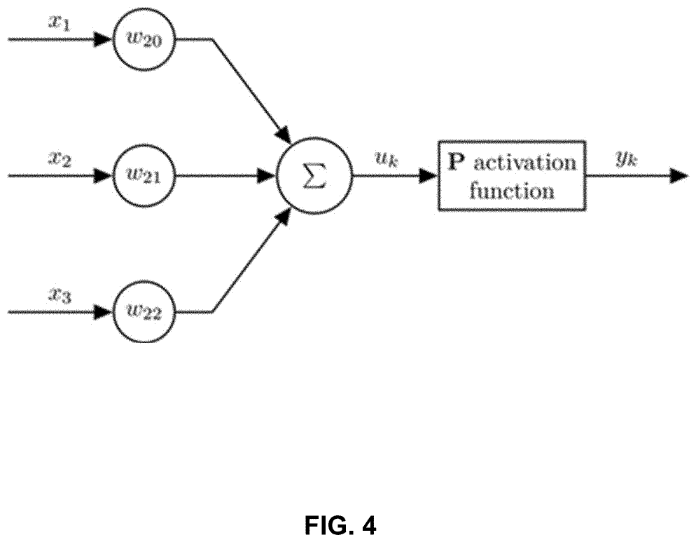

FIG. 4 depicts a single neuron schema that can be used in an example output neuron. Example descriptions of variables referenced herein can be as follows.

| Variable | Example description |
|---|---|
| r(k) | Setpoint |
| y(k) | Object output/neural network (NN) input |
| y(k + 1) | Next object output/NN input |
| u(k) | NN output |
| u(k − 1) | Previous NN output |
| x(k) | Outputs of hidden layer's neurons |
| uₛⱼ(k) | NN hidden layers output |
| uₛⱼ(k − 1) | Previous NN hidden layers output |
| sₛⱼ(k) | NN hidden layers input |
| sₛⱼ(k − 1) | Previous NN hidden layers input |
| xₛᵢ(k) | Outputs of input layer's neurons |
| wᵢₕ(n) | Input-hidden layer weights |
| wₕₒ(n) | Hidden-output layer weights |

Operation described as (1) can provide for neuron input signals x₁, x₂, . . . , xₙ being multiplied by a corresponding weight w₁, w₁, . . . , wₙ, and next added in summing element Σ.

$${u}_{k} = {\sum }_{i = 1}^{n} {w}_{i} {x}_{i} \qquad ( 1 )$$

The uₖ value can be passed to the activation function, where the yₖ output value is obtained. The activation functions of the neurons in the hidden layer can be different among nodes. A list of selected activation functions with their equations is presented in Table 1. The final output of a neuron can be described by (2).

$${y}_{k} = f ( {u}_{k} ) = f ( {w}_{i} , {x}_{i} ) = f ( {\sum }_{i = 1}^{n} {w}_{i} {x}_{i} ) \qquad ( 2 )$$

TABLE 1
Activation functons

| Function | Equation |
|---|---|
| P | ${y}_{k} = f ( {u}_{k} ) = \{ \begin{matrix}- 1 & for {u}_{k} < - 1 \\ {u}_{k} & for 1 \geq {u}_{k} \geq - 1 \\ 1 & for {u}_{k} > 1\end{matrix}$ |
| I | ${y}_{k} = f ( {u}_{k} ) = \{ \begin{matrix}max ( {y}_{k - 1} - 1 , {y}_{min} ) & for {u}_{k} < - 1 \\ max ( min ( {y}_{k - 1} + & for 1 \geq {u}_{k} \geq - 1 \\ {u}_{k} , {y}_{max} ) , {y}_{min} ) & \\ min ( {y}_{k - 1} + 1 , {y}_{max} ) & for {u}_{k} > 1\end{matrix}$ |
| D | ${y}_{k} = f ( {u}_{k} ) = \{ \begin{matrix}- 1 & for {u}_{k} - {u}_{k - 1} < - 1 \\ {u}_{k} - {u}_{k - 1} & for 1 \geq {u}_{k} \geq - 1 \\ 1 & for {u}_{k} - {u}_{k - 1} > 1\end{matrix}$ |

PID neural network weights can be adjusted based on backpropagation learning. The PID neural network attempts to minimize equation (3)

$$J = \frac{1}{m} {\sum }_{k = 1}^{m} {[ r ( k ) - y ( k ) ]}^{2} , \qquad ( 3 )$$

where m is the number of samples in the considered range. The weights of the NN can be changed by gradient algorithms during a training process. After n training steps, the weights from hidden layer to output layer can be represented as:

$$\begin{matrix}{w}_{h o} ( n + 1 ) = {w}_{h o} ( n ) - η \frac{δ J}{δ {w}_{h o}} , & ( 4 ) \\ where & \\ \frac{δ J}{δ {w}_{h o}} = - \frac{2}{m} {\sum }_{k = 1}^{m} [ r ( k ) - y ( k ) ] s g n ( \frac{{y}_{h} ( k + 1 ) - {y}_{h} ( k )}{{u}_{h} ( k ) - {u}_{h} ( k - 1 )} ) {x}_{h o} ( k ) = - \frac{1}{m} {\sum }_{k = 1}^{m} {δ}_{h} ( k ) {x}_{h o} ( k ) & ( 5 )\end{matrix}$$

The weights from input layer to hidden layer can be:

$$\begin{matrix}{w}_{i h} ( n + 1 ) = {w}_{i h} ( n ) - η \frac{δ J}{δ {w}_{i h}} , & ( 6 ) \\ where & \\ \frac{δ J}{δ {w}_{i h}} = - \frac{1}{m} {\sum }_{k = 1}^{m} {δ}_{h} ( k ) {w}_{h o} s g n ( \frac{{u}_{sj} ( k ) - {u}_{s j} ( k - 1 )}{{s}_{sj} ( k ) - {s}_{s j} ( k - 1 )} ) {x}_{i h} ( k ) = - \frac{1}{m} {\sum }_{k = 1}^{m} {δ}_{{w}_{h o}} ( k ) {x}_{i h} ( k ) & ( 7 )\end{matrix}$$

Backpropagation can be used for learning neural networks using a gradient of a loss function with respect to the weights of NN. In some examples, learning includes multiple gradient descent calculations per single weight update, which leads to storing previous states of the neural network. Storing previous states of a neural network can utilize memory and memory bandwidth, which are shared by other processes and can be overutilized. Some examples utilize iterative backpropagation based on the current and the previous state of a neural network to operate. Changes to weights that could be applied to current weights of the neural network can be updated in one or more iterations of a control loop or can be applied to the neural network in a period defined by a user. Memory and memory bandwidth utilization can be significantly reduced compared to performing backpropagation in the time domain.

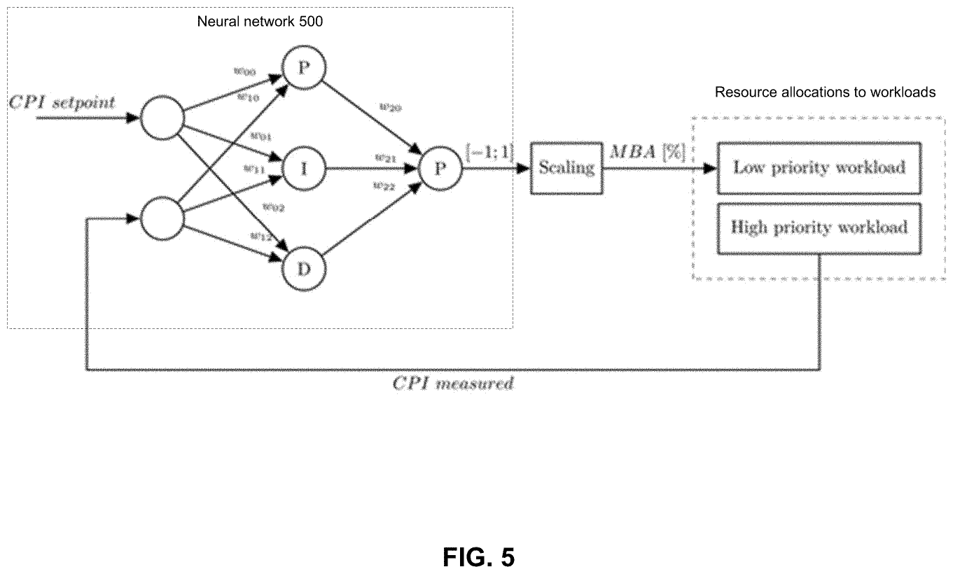

FIG. 5 depicts an example control loop utilizing a neural network. For example, a PIDNN controller can utilize neural network 500 to adjust memory bandwidth allocated to a LP workload to attempt to achieve a CPI setpoint for an HP workload based on a CPI measured for the HP workload. Neural network 500 can output a percentage of memory bandwidth allocation (MBA) to a LP workload. Accordingly, neural network 500 can throttle performance of a LP workload so that a CPI setpoint of a HP workload can be met. An uncore or system agent can include circuitry that can throttle a number of memory requests sent to memory from an LP workload based on percentage of MBA received from neural network 500.

While examples are described with respect to allocation of MBA to an LP workload, allocation of MBA can be made to an HP workload. Allocation of other resources to an LP or HP workload can be made based on CPI setpoint and CPI measured, where resources include one or more of: cache allocation, processor frequency, network bandwidth, PCIe interface bandwidth, CXL interface bandwidth, core simultaneous multithreading (SMT) pipeline resources, and so forth. More generally, PIDNN controller can adjust resource allocation to an LP and/or HP workload to attempt to achieve one or more target parameters or setpoints. Target parameters or setpoints can include CPI setpoint, target memory latency, target cache occupancy, target device or system temperature, target power level, target failure rate, target device bandwidth, or other parameters.

The operation of neural network 500 can be influenced by limitations of outputs from the nodes. P, I, and D nodes may have an output range of [−1, 1], so that an overall output range from neural network 500 is also [−1, 1], since the output neuron is a P node. Depending on the specific application, the input nodes can be either activated with the P node or not activated. In case where an input and output are limited to a range, a linear mapping of object ranges to PID neural network ranges can take place. An example linear mapping function is described by equation (6).

$$f ( x ) = \frac{{y}_{1} - {y}_{0}}{{x}_{1} - {x}_{0}} * ( x - {x}_{0} ) + {y}_{0} , \qquad ( 6 )$$

where input range is [x₀, x₁] and output range is [y₀, y₁].

However, in some cases, the operating conditions of a system may not be known in advance and the static linear mapping of output from the system to the input of PID neural network may lead to suboptimal operation of the controlled system because PIDNN may behave in an unstable manner or overreact when input values are not adjusted to internal dynamics of PIDNN.

For example, the equation (7) can potentially approximate behavior of some of the workloads running in a multi-workload environment on the server platform.

$$y ( t + Δ t ) = y ( t ) * {e}^{\frac{- t}{τ}} + u ( t ) * ( 1 - {e}^{\frac{- t}{τ}} ) , \qquad ( 7 )$$

where:
τ represents a time constant,

y(t) represents an objects output,

u(t) represents an objects input.

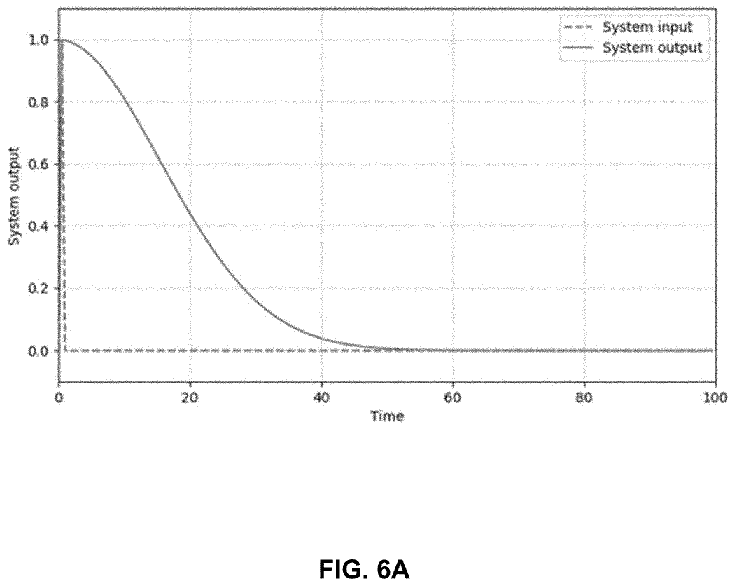

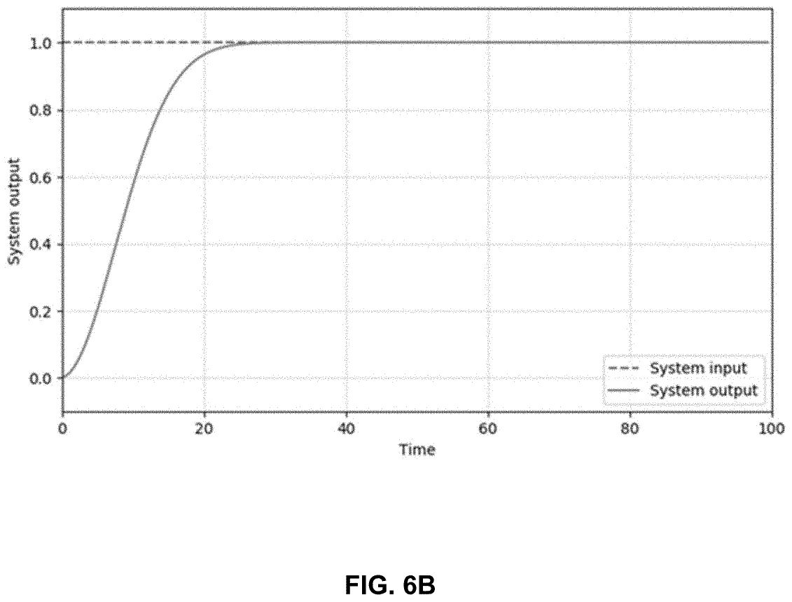

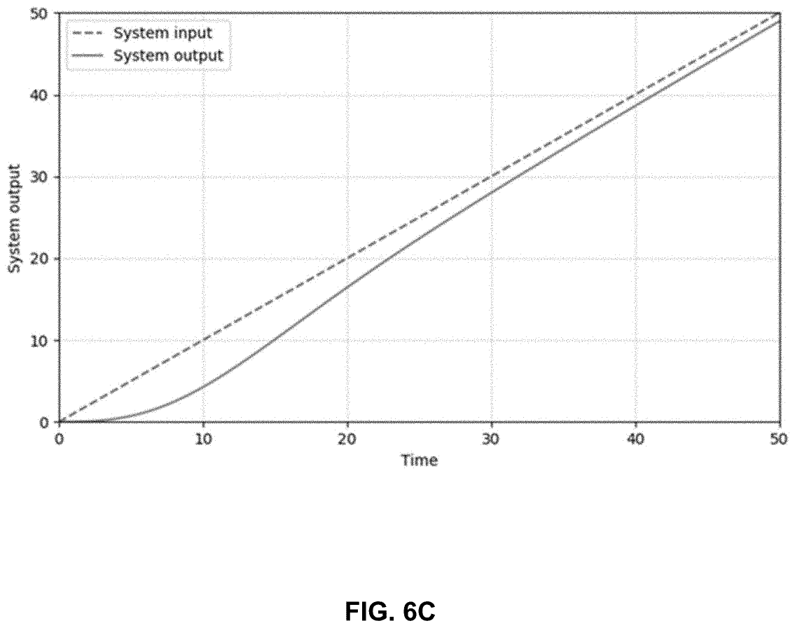

FIGS. 6A-6C present dynamics of the model of equation (7) that depict behavior of a tested system in response to a unit impulse, unit step, and unit ramp respectively. FIG. 6A depicts an example of unit impulse response. FIG. 6B depicts an example of unit step response. FIG. 6C depicts an example of unit ramp response. Oscillations can lead to a longer time to achieve a desired setpoint, larger overall error (e.g., sum of setpoint−current value), and generally unacceptable control quality, among other issues.

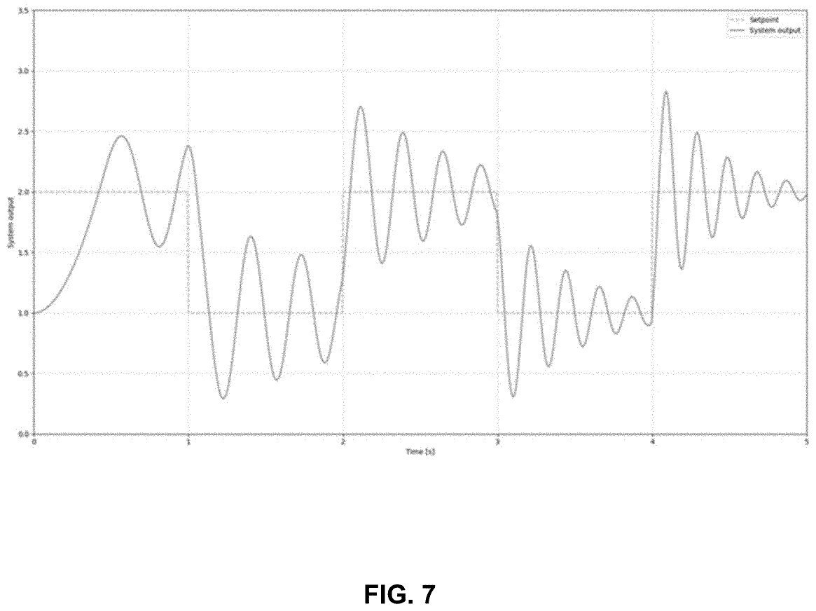

FIG. 7 depicts reactions to a step function and simulates changing a CPI setpoint during execution of a workload. In particular, the object described by equation (7) was tested with neural network with initial values described by Table 1.

TABLE 1
Parameters of used PIDNN.

| Input-hidden | Hidden-output | | Input nodes |
|---|---|---|---|
| weights | weights | I node output range | activation |
| [−1, 1, −1, 1, −1, 1] | [0.1, 0.1, 0.1] | [−10; 10] | None |

Damped oscillations are shown with relatively high amplitude, which can lead to longer time to achieve a setpoint, larger error, and generally unacceptable control quality, among other issues.

To potentially at least partially address issues of instability or overreaction based on input values, a dynamic manner of mapping inputs to the PID neural network can be utilized. A dynamic range of inputs to a NN utilized by a PID controller can be determined for one or more control loop outputs or iteration of control loop output. The dynamic range of inputs can be changed based on output from PID controller and desired setpoint. Dynamic linear mapping can be applied at outputs of a neural network to update output mapping range in one or more iterations of a control loop, basing on a current value of the controlled process variable. A value δ can be added to or subtracted from a current measurement of a controlled process value (CPI) calculate minimum and the maximum values of the δ. In some examples, 8=1, or a certain percent of measured process variable, e.g., δ=0.1*pv. Linear mapping in equation (6) can be used on the input range to map it to a PIDnnₘᵢₙNN input range [nnₘᵢₙ, nnₘₐₓ] (e.g. [0, 1]) to normalize unknown magnitudes of input values. Mapped values can be provided to the PIDNN as inputs.

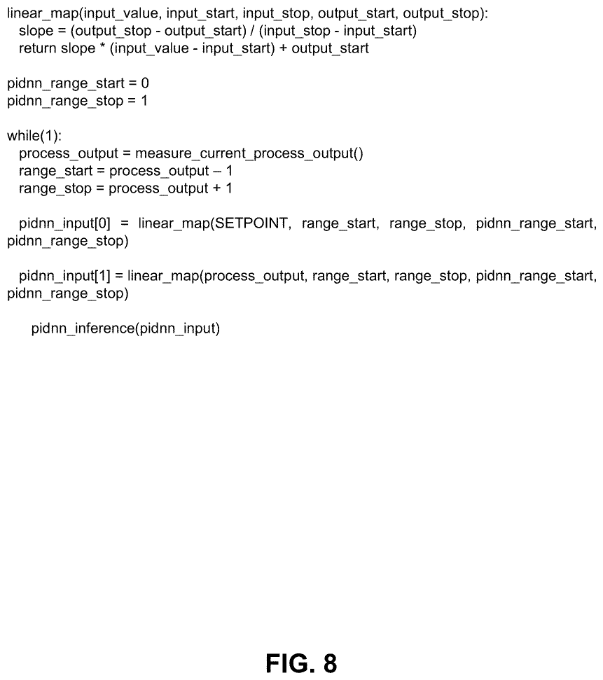

FIG. 8 depicts an example pseudocode for dynamic linear mapping of inputs to a neural network. A PID neural network can perform pseudocode to apply dynamic linear mapping of an input value range. The pseudocode can be repeatedly applied for iterations of a control loop to define a range of input values for iterations of control loop. In some examples, the system can include a PIDNN controller that includes circuitry or programmable circuitry to scale inputs as described herein.

Registers or a memory can store values of variables pidnn_range_start, pidnn_range_stop, range_start, range_stop, and SETPOINT. SETPOINT can represent a CPI setpoint for an HP workload, amount of memory bandwidth allocation to an HP workload, or other values of target resource allocation to an HP workload.

Code segment pidnn_input[0]=linear_map(SETPOINT, range_start, range_stop, pidnn_range_start, pidnn_range_stop) can linearly map a SETPOINT value to another input value based on a slope of (pidnn_range_stop−pidnn_range_start)/(range_stop−range_start). Variable pidnn_range_start can represent a lowest possible starting value after re-mapping. In some examples, pidnn_range_start can be initialized to zero. Variable pidnn_range_stop can represent a highest possible starting value after re-mapping. Variable pidnn_range_stop can be initialized to one. Variable range_start can represent an adjusted lower output value from the NN such as reduced by 1 or multiplied by a reducing scaling factor. Variable range_stop can represent an adjusted upper or higher output value from the NN such as increased by 1 or multiplied by a-scaling factor.

Code segment pidnn_input[1]=linear_map(process_output_range, range_start, range_stop, pidnn_range_start, pidnn_range_stop) can linearly map a process_output_range value to another input value based on a slope of (pidnn_range_stop−pidnn_range_start)/(range_stop−range_start). Variable process_output_range can represent a measured CPI of an HP workload, measured amount of memory bandwidth allocation of an HP workload, or other measured values of resource allocation to an HP workload.

Code segment pidnn_inference(pidnn_input), where pidnn_input can be adjusted CPI setpoint and adjusted measured CPI, can provide an output of an MBA allocation or other resource allocation to a LP workload based on use of a neural network, such as the neural network described with respect to FIG. 3.

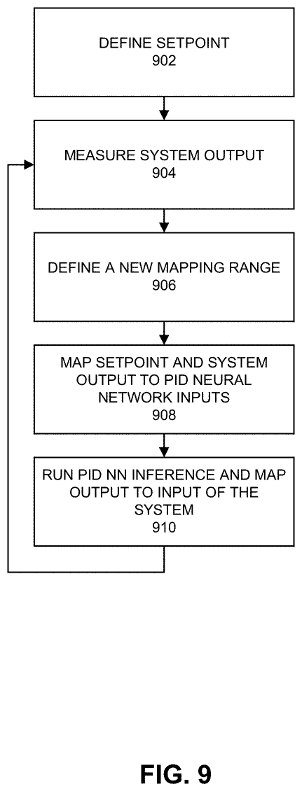

FIG. 9 depicts an example of a process to perform dynamic linear mapping of inputs to a neural network. The process can be performed by a PID controller that uses a neural network to generate a control signal to control resource allocation to an LP workload. At 902, a setpoint can be defined for a control loop. Examples setpoints include a CPI setpoint of an HP workload. Other setpoints can be specified. At 904, a control system output can be measured. For example, a system output can represent a measured performance of an HP workload. For example, the system output can include memory bandwidth allocation, cache allocation, core frequency, or others. At 906, an input mapping range can be defined. For example, the pseudocode of FIG. 8 can be used to define an input mapping range. At 908, setpoint level and measured output level can be adjusted based on the mapping range. Adjustment can include a linear adjustment of setpoint level and measured output level. At 910, a neural network can receive adjusted inputs of setpoint level and measured output level and generate an output of a resource allocation. The output can include a memory bandwidth allocation, cache allocation, core frequency, or others.

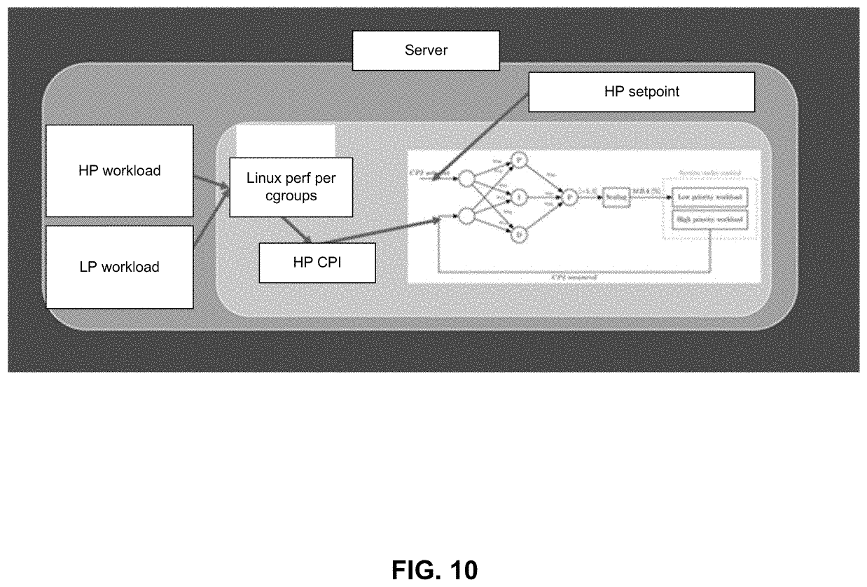

FIG. 10 depicts an example environment. In this example, cgroup can represent a container, and Linux® instruction perf per cgroups can be utilized to access measured CPI for the container. The measured CPI can be scaled and provide as an input to a neural network to generate a resource allocation output for an LP workload.

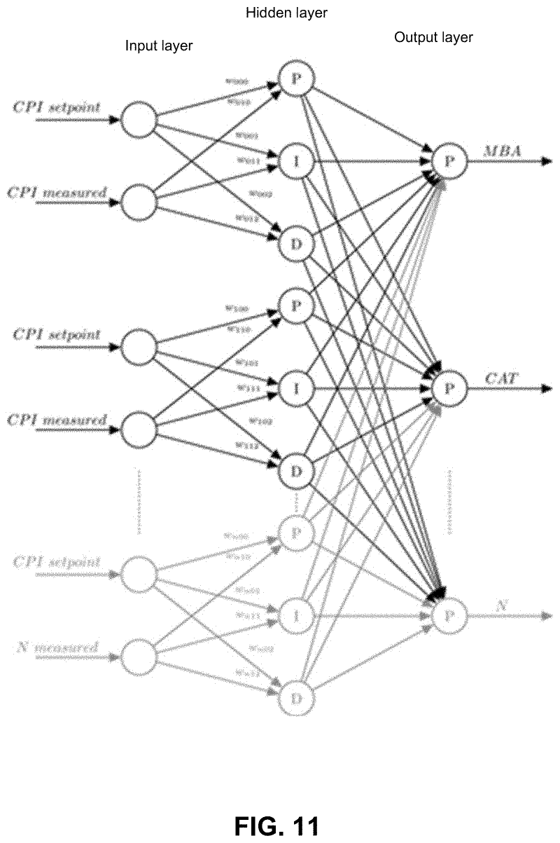

FIG. 11 depicts an example control loop for a multiple input, multiple output (MIMO) neural network. Based on a received set of performance targets for multiple applications running on one or more processors (e.g., CPI set points) and measured performance (e.g., CPI measured), a PID controller can utilize a MIMO neural network to adjust multiple shared resources such as memory bandwidth, cache (e.g., cache allocation technology (CAT)), power frequency supply, device interface bandwidth (e.g., PCIe or CXL bandwidth), memory capacity, and so forth.

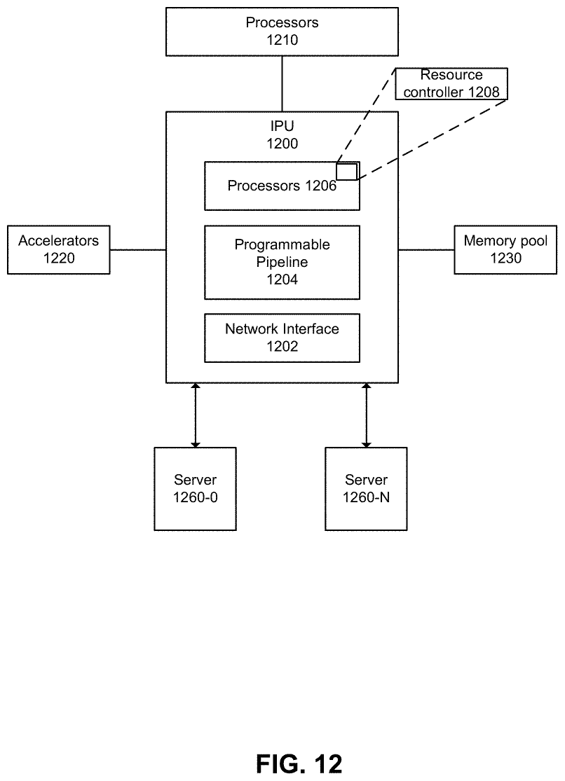

FIG. 12 depicts an example system. In this system, IPU 1200 manages performance of one or more processes using one or more of processors 1206, processors 1210, accelerators 1220, memory pool 1230, or servers 1240-0 to 1240-N, where N is an integer of 1 or more. In some examples, processors 1206 of IPU 1200 can execute one or more processes, applications, VMs, containers, microservices, and so forth that request performance of workloads by one or more of: processors 1210, accelerators 1220, memory pool 1230, and/or servers 1240-0 to 1240-N. IPU 1200 can utilize network interface 1202 or one or more device interfaces to communicate with processors 1210, accelerators 1220, memory pool 1230, and/or servers 1240-0 to 1240-N. IPU 1200 can utilize programmable pipeline 1204 to process packets that are to be transmitted from network interface 1202 or packets received from network interface 1202. Programmable pipeline 1204 and/or processors 1206 can include resource controller circuitry 1208 to adjust resources allocated to performance of a workload based on use of a neural network with range adjusted inputs, as described herein.

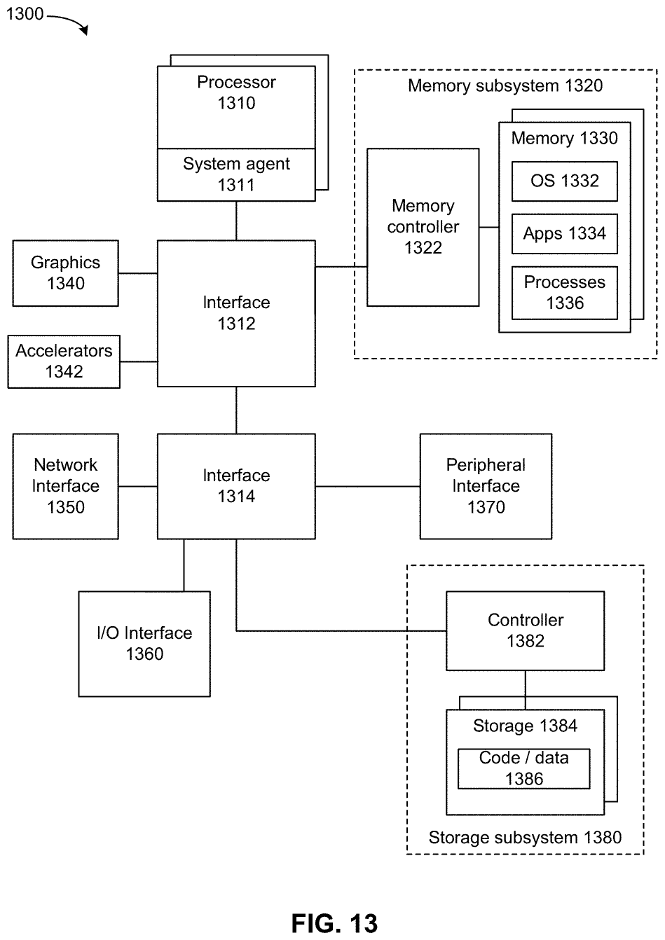

FIG. 13 depicts a system. Components of system 1300 (e.g., processor 1310) can include circuitry to adjust resources allocated to performance of a workload based on use of a neural network with range adjusted inputs, as described herein. In some examples, a single server can include one or more components of system 1300. In some examples, disaggregated or composite servers can be formed from one or multiple servers to execute processes. Multi-tenant environments can be supported by the disaggregated or composite servers. Workloads from different tenants can be executed for different tenants. In some examples, a PIDNN controller can adjust resource allocation during execution of one or more processes or workloads as described herein.

System 1300 includes processor 1310, which provides processing, operation management, and execution of instructions for system 1300. Processor 1310 can include any type of microprocessor, central processing unit (CPU), graphics processing unit (GPU), XPU, processing core, or other processing hardware to provide processing for system 1300, or a combination of processors. An XPU can include one or more of: a CPU, a graphics processing unit (GPU), general purpose GPU (GPGPU), and/or other processing units (e.g., accelerators or programmable or fixed function FPGAs). Processor 1310 controls the overall operation of system 1300, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

An uncore or system agent 1311 can include or more of a memory controller, a shared cache (e.g., last level cache (LLC)), a cache coherency manager, arithmetic logic units, floating point units, core or processor interconnects, Caching/Home Agent (CHA), or bus or link controllers. System agent 1311 can provide one or more of: direct memory access (DMA) engine connection, non-cached coherent master connection, data cache coherency between cores and arbitrates cache requests, or Advanced Microcontroller Bus Architecture (AMBA) capabilities. System agent 1311 can include circuitry that can adjust resources allocated to performance of a workload based on use of a neural network with range adjusted inputs, as described herein. In some examples, system agent 1311 includes the PIDNN controller.

In one example, system 1300 includes interface 1312 coupled to processor 1310, which can represent a higher speed interface or a high throughput interface for system components that needs higher bandwidth connections, such as memory subsystem 1320 or graphics interface components 1340, or accelerators 1342. Interface 1312 represents an interface circuit, which can be a standalone component or integrated onto a processor die. Where present, graphics interface 1340 interfaces to graphics components for providing a visual display to a user of system 1300. In one example, graphics interface 1340 can drive a display that provides an output to a user. In one example, the display can include a touchscreen display. In one example, graphics interface 1340 generates a display based on data stored in memory 1330 or based on operations executed by processor 1310 or both. In one example, graphics interface 1340 generates a display based on data stored in memory 1330 or based on operations executed by processor 1310 or both.

Accelerators 1342 can be a programmable or fixed function offload engine that can be accessed or used by a processor 1310. For example, an accelerator among accelerators 1342 can provide data compression (DC) capability, cryptography services such as public key encryption (PKE), cipher, hash/authentication capabilities, decryption, or other capabilities or services. In some embodiments, in addition or alternatively, an accelerator among accelerators 1342 provides field select controller capabilities as described herein. In some cases, accelerators 1342 can be integrated into a CPU socket (e.g., a connector to a motherboard or circuit board that includes a CPU and provides an electrical interface with the CPU). For example, accelerators 1342 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 1342 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 1320 represents the main memory of system 1300 and provides storage for code to be executed by processor 1310, or data values to be used in executing a routine. Memory subsystem 1320 can include one or more memory devices 1330 such as read-only memory (ROM), flash memory, one or more varieties of random access memory (RAM) such as DRAM, or other memory devices, or a combination of such devices. Memory 1330 stores and hosts, among other things, operating system (OS) 1332 to provide a software platform for execution of instructions in system 1300. Additionally, applications 1334 can execute on the software platform of OS 1332 from memory 1330. Applications 1334 represent programs that have their own operational logic to perform execution of one or more functions. Processes 1336 represent agents or routines that provide auxiliary functions to OS 1332 or one or more applications 1334 or a combination. OS 1332, applications 1334, and processes 1336 provide software logic to provide functions for system 1300. In one example, memory subsystem 1320 includes memory controller 1322, which is a memory controller to generate and issue commands to memory 1330. It will be understood that memory controller 1322 could be a physical part of processor 1310 or a physical part of interface 1312. For example, memory controller 1322 can be an integrated memory controller, integrated onto a circuit with processor 1310.

Applications 1334 and/or processes 1336 can utilize hardware resources of system 1300 by issuing workloads of various priority levels. Circuitry in system agent 1311 can adjust resources allocated to performance of a low and high priority workloads based on use of a neural network with range adjusted inputs, as described herein

Applications 1334 and/or processes 1336 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

A virtualized execution environment (VEE) can include at least a virtual machine or a container. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from another, allowing virtual machines to run Linux®, Windows® Server, VMware ESXi, and other operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers may be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

In some examples, OS 1332 can be Linux®, Windows® Server or personal computer, FreeBSD®, Android®, MacOS®, iOS®, VMware vSphere, openSUSE, RHEL, CentOS, Debian, Ubuntu, or any other operating system. OS 1332 and driver can execute on a processor sold or designed by Intel®, ARM®, AMD®, Qualcomm®, IBM®, Nvidia®, Broadcom®, Texas Instruments®, among others. OS 1332 and/or driver can configure system agent 1311 to adjust resources allocated to performance of a workload based on use of a neural network with range adjusted inputs, as described herein.

While not specifically illustrated, it will be understood that system 1300 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1300 includes interface 1314, which can be coupled to interface 1312. In one example, interface 1314 represents an interface circuit, which can include standalone components and integrated circuitry. In one example, multiple user interface components or peripheral components, or both, couple to interface 1314. Network interface 1350 provides system 1300 the ability to communicate with remote devices (e.g., servers or other computing devices) over one or more networks. Network interface 1350 can include an Ethernet adapter, wireless interconnection components, cellular network interconnection components, USB (universal serial bus), or other wired or wireless standards-based or proprietary interfaces. Network interface 1350 can transmit data to a device that is in the same data center or rack or a remote device, which can include sending data stored in memory. Network interface 1350 (e.g., packet processing device) can execute a virtual switch to provide virtual machine-to-virtual machine communications for virtual machines (or other VEEs) in a same server or among different servers. Network interface 1350 can receive data from a remote device, which can include storing received data into memory. In some examples, network interface 1350 can refer to one or more of: a network interface controller (NIC), a remote direct memory access (RDMA)-enabled NIC, SmartNIC, router, switch, forwarding element, infrastructure processing unit (IPU), or data processing unit (DPU).

In one example, system 1300 includes one or more input/output (I/O) interface(s) 1360. I/O interface 1360 can include one or more interface components through which a user interacts with system 1300 (e.g., audio, alphanumeric, tactile/touch, or other interfacing). Peripheral interface 1370 can include any hardware interface not specifically mentioned above. Peripherals refer generally to devices that connect dependently to system 1300. A dependent connection is one where system 1300 provides the software platform or hardware platform or both on which operation executes, and with which a user interacts.

In one example, system 1300 includes storage subsystem 1380 to store data in a nonvolatile manner. In one example, in certain system implementations, at least certain components of storage 1380 can overlap with components of memory subsystem 1320. Storage subsystem 1380 includes storage device(s) 1384, which can be or include any conventional medium for storing large amounts of data in a nonvolatile manner, such as one or more magnetic, solid state, or optical based disks, or a combination. Storage 1384 holds code or instructions and data 1386 in a persistent state (e.g., the value is retained despite interruption of power to system 1300). Storage 1384 can be generically considered to be a “memory,” although memory 1330 is typically the executing or operating memory to provide instructions to processor 1310. Whereas storage 1384 is nonvolatile, memory 1330 can include volatile memory (e.g., the value or state of the data is indeterminate if power is interrupted to system 1300). In one example, storage subsystem 1380 includes controller 1382 to interface with storage 1384. In one example controller 1382 is a physical part of interface 1314 or processor 1310 or can include circuits or logic in both processor 1310 and interface 1314.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). Another example of volatile memory includes cache or static random access memory (SRAM).

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, or NVM devices that use chalcogenide phase change material (for example, chalcogenide glass).

A power source (not depicted) provides power to the components of system 1300. More specifically, power source typically interfaces to one or multiple power supplies in system 1300 to provide power to the components of system 1300. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 1300 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

In an example, system 1300 can be implemented using interconnected compute sleds of processors, memories, storages, network interfaces, and other components. High speed interconnects can be used such as PCIe, Ethernet, or optical interconnects (or a combination thereof).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” or “logic.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for another. For example, descriptions using the terms “connected” and/or “coupled” may indicate that two or more elements are in direct physical or electrical contact with another. The term “coupled,” however, may also mean that two or more elements are not in direct contact with another, but yet still co-operate or interact with another.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Various components described herein can be a means for performing the operations or functions described. A component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, and so forth.

Some examples include an apparatus comprising: circuitry to utilize a neural network with proportional, integral, and derivative activation functions (PIDNN) which can adjust its weights to adjust one or more parameters allocated to a first group of one or more workloads based on one or more target parameters for a second group of one or more workloads, wherein the circuitry is to adjust inputs to the neural network to a range based on at least one output from the neural network.

In some examples, the one or more target parameters comprise a setpoint performance level and measured performance level and wherein to adjust inputs to the neural network to a range based on at least one output from the neural network, the circuitry is to adjust the setpoint performance level and measured performance level.

In some examples, to adjust inputs to the neural network to a range based on at least one output from the neural network, the circuitry is to range bound the at least one output from the neural network and wherein the at least one input to the neural network comprises the range bounded at least one output from the neural network.

In some examples, to adjust inputs to the neural network to a range based on at least one output from the neural network, the circuitry is to apply linear range adjustment.

In some examples, the one or more parameters allocated to the first group of one or more workloads comprises allocated memory bandwidth and the one or more target parameters for the second group of one or more workloads is based on a target cycles per instruction (CPI).

In some examples, the neural network comprises an input layer, single hidden layer, and an output layer.

In some examples, the neural network comprises a multiple input multiple output neural network that is to receive performance targets for multiple workloads and adjust multiple shared resources.

In some examples, the multiple shared resources are interrelated and comprise two or more of: memory bandwidth, cache allocation, power level, processor frequency, device interface bandwidth, or memory capacity.

Some examples include a server comprising: at least one processor to execute the first group of one or more workloads and the second group of one or more workloads; at least one memory device; at least one device interface; at least one cache device, wherein the one or more parameters allocated to the first group of one or more workloads comprises one or more of: memory bandwidth allocation of the at least one memory device, bandwidth allocation in the at least one device interface, or allocation in the at least one cache device.

Some examples include a non-transitory computer-readable medium comprising instructions stored thereon, that if executed by one or more processors, cause the one or more processors to: utilize a proportional, integral, derivative neural network (PIDNN) controller to adjust weights to adjust one or more parameters allocated to a first group of one or more workloads based on one or more target parameters for a second group of one or more workloads and adjust inputs to the neural network to a range based on at least one output from the neural network.

In some examples, the one or more target parameters comprise a setpoint performance level and measured performance level and wherein to adjust inputs to the neural network to a range based on at least one output from the neural network comprises adjust the setpoint performance level and measured performance level.

In some examples, wherein to adjust inputs to the neural network to a range based on at least one output from the neural network comprises range bound the at least one output from the neural network and wherein the at least one output from the neural network comprises the range bounded at least one output from the neural network.

In some examples, inputs to the neural network are adjusted to a range is based on at least one output from the neural network comprises apply linear range adjustment.

In some examples, the one or more parameters allocated to the first group of one or more workloads comprises allocated memory bandwidth and the one or more target parameters for the second group of one or more workloads is based on a target cycles per instruction (CPI).

In some examples, adjust one or more parameters allocated to a first group of one or more workloads is based on one or more target parameters for a second group of one or more workloads comprises adjust memory bandwidth allocated to at least one low priority workload based on a target cycles per instruction (CPI) for at least one high priority workload.

In some examples, the neural network comprises an input layer, single hidden layer, and an output layer.

In some examples, the neural network comprises a multiple input multiple output neural network and the multiple shared resources are interrelated and comprise two or more of: memory bandwidth, cache allocation, power level, processor frequency, device interface bandwidth, or memory capacity.

Some examples include a method that includes: utilizing a proportional, integral, derivative neural network (PIDNN) controller to adjust one or more parameters allocated to a first group of one or more workloads based on one or more target parameters for a second group of one or more workloads and adjusting inputs to the neural network to a range based on at least one output from the neural network.

In some examples, the one or more target parameters comprise a setpoint performance level and measured performance level and wherein adjusting inputs to the neural network to a range based on at least one output from the neural network comprises adjusting the setpoint performance level and measured performance level.

In some examples, adjusting inputs to the neural network to a range is based on at least one output from the neural network comprises range bounding the at least one output from the neural network and wherein the at least one output from the neural network comprises the range bounded at least one output from the neural network.

Example 1 can include an apparatus comprising: circuitry to utilize a proportional, derivative, integral neural network (PIDNN) controller to adjust one or more parameters allocated to a first group of one or more workloads based on one or more target parameters for a second group of one or more workloads.

Example 2 can include one or more examples, wherein the second group of one or more workloads are a same, lower, or higher priority level than that of the first group of one or more workloads.

Example 3 can include one or more examples, wherein the one or more parameters allocated to the first group of one or more workloads comprises allocated memory bandwidth.

Example 4 can include one or more examples, wherein the one or more target parameters for the second group of one or more workloads is based on a target parameter.

Example 5 can include one or more examples, wherein the adjust one or more parameters allocated to a first group of one or more workloads based on one or more target parameters for a second group of one or more workloads comprises adjust memory bandwidth allocated to at least one low priority workload based on a target cycles per instruction (CPI) for at least one high priority workload.

Example 6 can include one or more examples, wherein the neural network comprises a single input single output neural network.

Example 7 can include one or more examples, wherein the neural network comprises an input layer, single hidden layer, and an output layer.

Example 8 can include one or more examples, wherein the neural network comprises a multiple input multiple output neural network.

Example 9 can include one or more examples, wherein the multiple input multiple output neural network is to receive performance targets for multiple workloads and adjust multiple shared resources.

Example 10 can include one or more examples, wherein the multiple shared resources are interrelated and comprise two or more of: memory bandwidth, cache allocation, power level, processor frequency, device interface bandwidth, thermal state, failure rate, or memory capacity.

Example 11 can include one or more examples, wherein the circuitry is to tune weights of the neural network based on incremental backpropagation format.

Example 12 can include one or more examples, wherein the circuitry is to adjust a linearly adjusted input range to the PIDNN controller for at least one control loop iteration.

Example 13 can include one or more examples, and includes a server comprising: at least one processor to execute the first group of one or more workloads and the second group of one or more workloads; at least one memory device; at least one device interface; at least one cache device, wherein the one or more parameters allocated to the first group of one or more workloads comprises one or more of: memory bandwidth allocation of the at least one memory device, bandwidth allocation in the at least one device interface, or allocation in the at least one cache device.

Example 14 can include one or more examples, and includes a non-transitory computer-readable medium comprising instructions stored thereon, that if executed by one or more processors, cause the one or more processors to: cause utilization of a proportional, integral, derivative neural network (PIDNN) controller to adjust one or more parameters allocated to a first group of one or more workloads based on one or more target parameters for a second group of one or more workloads.

Example 15 can include one or more examples, wherein the second group of one or more workloads are a same, lower, or higher priority level than that of the first group of one or more workloads.

Example 16 can include one or more examples, wherein the one or more parameters allocated to the first group of one or more workloads comprises allocated memory bandwidth and the one or more target parameters for the second group of one or more workloads is based on a target cycles per instruction (CPI).

Example 17 can include one or more examples, wherein the adjust one or more parameters allocated to a first group of one or more workloads based on one or more target parameters for a second group of one or more workloads comprises adjust memory bandwidth allocated to at least one low priority workload based on a target cycles per instruction (CPI) for at least one high priority workload.

Example 18 can include one or more examples, wherein the neural network comprises a single input single output neural network.

Example 19 can include one or more examples, wherein the neural network comprises an input layer, single hidden layer, and an output layer.

Example 20 can include one or more examples, wherein the neural network comprises a multiple input multiple output neural network.

Example 21 can include one or more examples, wherein the multiple shared resources are interrelated and comprise two or more of: memory bandwidth, cache allocation, power level, processor frequency, device interface bandwidth, or memory capacity.

What is claimed is:

1. An apparatus comprising:
circuitry to utilize a proportional, derivative, integral neural network (PIDNN) controller to adjust one or more parameters allocated to a first group of one or more workloads based on one or more target parameters for a second group of one or more workloads.

2. The apparatus of claim 1, wherein the second group of one or more workloads are a same, lower, or higher priority level than that of the first group of one or more workloads.

3. The apparatus of claim 1, wherein
the one or more parameters allocated to the first group of one or more workloads comprises allocated memory bandwidth.

4. The apparatus of claim 1, wherein
the one or more target parameters for the second group of one or more workloads is based on a target parameter.

5. The apparatus of claim 1, wherein the adjust one or more parameters allocated to a first group of one or more workloads based on one or more target parameters for a second group of one or more workloads comprises adjust memory bandwidth allocated to at least one low priority workload based on a target cycles per instruction (CPI) for at least one high priority workload.

6. The apparatus of claim 1, wherein the neural network comprises a single input single output neural network.

7. The apparatus of claim 1, wherein the neural network comprises an input layer, single hidden layer, and an output layer.

8. The apparatus of claim 1, wherein the neural network comprises a multiple input multiple output neural network.

9. The apparatus of claim 8, wherein the multiple input multiple output neural network is to receive performance targets for multiple workloads and adjust multiple shared resources.

10. The apparatus of claim 9, wherein the multiple shared resources are interrelated and comprise two or more of: memory bandwidth, cache allocation, power level, processor frequency, device interface bandwidth, thermal state, failure rate, or memory capacity.

11. The apparatus of claim 1, wherein the circuitry is to tune weights of the neural network based on incremental backpropagation format.

12. The apparatus of claim 1, wherein the circuitry is to adjust a linearly adjusted input range to the PIDNN controller for at least one control loop iteration.

13. The apparatus of claim 1, further comprising:
a server comprising:
at least one processor to execute the first group of one or more workloads and the second group of one or more workloads;
at least one memory device;
at least one device interface;
at least one cache device, wherein the one or more parameters allocated to the first group of one or more workloads comprises one or more of: memory bandwidth allocation of the at least one memory device, bandwidth allocation in the at least one device interface, or allocation in the at least one cache device.

14. A non-transitory computer-readable medium comprising instructions stored thereon, that if executed by one or more processors, cause the one or more processors to:
cause utilization of a proportional, integral, derivative neural network (PIDNN) controller to adjust one or more parameters allocated to a first group of one or more workloads based on one or more target parameters for a second group of one or more workloads.

15. The computer-readable medium of claim 14, wherein the second group of one or more workloads are a same, lower, or higher priority level than that of the first group of one or more workloads.

16. The computer-readable medium of claim 14, wherein
the one or more parameters allocated to the first group of one or more workloads comprises allocated memory bandwidth and the one or more target parameters for the second group of one or more workloads is based on a target cycles per instruction (CPI).

17. The computer-readable medium of claim 14, wherein the adjust one or more parameters allocated to a first group of one or more workloads based on one or more target parameters for a second group of one or more workloads comprises adjust memory bandwidth allocated to at least one low priority workload based on a target cycles per instruction (CPI) for at least one high priority workload.

18. The computer-readable medium of claim 14, wherein the neural network comprises a single input single output neural network.

19. The computer-readable medium of claim 14, wherein the neural network comprises an input layer, single hidden layer, and an output layer.

20. The computer-readable medium of claim 14, wherein the neural network comprises a multiple input multiple output neural network.

21. The computer-readable medium of claim 14, wherein the multiple shared resources are interrelated and comprise two or more of: memory bandwidth, cache allocation, power level, processor frequency, device interface bandwidth, or memory capacity.
